(19) United States
(12) Patent Application Publication
(10) Pub. No.: US 2015/0113454 A1
(43) Pub. Date: Apr. 23, 2015

(54) Delivery of Contextual Data to a Computing Device Using Eye Tracking Technology

(71) Applicant: Motorola Mobility LLC, Chicago, IL (US)

(72) Inventor: Michael D. McLaughlin, San Jose, CA (US)

(73) Assignee: Motorola Mobility LLC, Chicago, IL (US)

(21) Appl. No.: 14/269,746

(22) Filed: May 5, 2014

Related U.S. Application Data
(60) Provisional application No. 61/893,867, filed on Oct. 21, 2013.

(51) Int. Cl. G06F 3/01; G06F 3/0481

(52) U.S. Cl. CPC G06F 3/013; G06F 3/0481
USPC 715/765

(57) ABSTRACT

A method, device, system, or article of manufacture is provided for improved delivery of contextual data to a computing device using eye tracking technology. In one embodiment, receiving, by a computing device, first content and second content; outputting, by the computing device, for display, the first content to a first region of a graphical user interface and the second content to a second region of the graphical user interface; accumulating a first gaze duration associated with a user viewing the first region of the graphical user interface; accumulating a second gaze duration associated with a user viewing the second region of the graphical user interface; determining a first metric associated with the first content and a second metric associated with the second content using the first gaze duration and the second gaze duration; and sending, from the computing device, the first metric and the second metric.

### CROSS REFERENCE TO PRIOR APPLICATION(S)

This application claims priority and benefit under 35 U.S.C. §119(e) from U.S. Provisional Application No. 61/893,867, filed Oct. 21, 2013.

### FIELD OF USE

The embodiments described herein relate to computing devices and more particularly to improved delivery of contextual data to a computing device using eye tracking technology.

### BACKGROUND

Mobile communications services such as wireless telephony, wireless data services, wireless short message services (SMS), wireless e-mail and the like are typically used for business and personal purposes. These services provide real-time or near real-time delivery of electronic communications, which make them amenable for use in delivering contextual data to a computing device such as a smartphone. For example, a user can perform a search using a web browser application and can select a particular search result to gain immediate access to the desired information. For another example, mobile communication services may be used for a mapping app, which provides useful information about a particular location selected by a user. Furthermore, eye tracking technology has emerged as a viable option for users to interact with computing devices. This technology allows the detection of a user's eye or eye lid movements to determine, for instance, a user's gaze direction such as on a display of a computing device. However, the use of eye tracking technology has had limited adoption for use in, for instance, consumer products such as smartphones.

### BRIEF DESCRIPTION OF THE FIGURES

The present disclosure is illustrated by way of examples, embodiments and the like and is not limited by the accompanying figures, in which like reference numbers indicate similar elements. Elements in the figures are illustrated for simplicity and clarity and have not necessarily been drawn to scale. The figures along with the detailed description are incorporated and form part of the specification and serve to further illustrate examples, embodiments and the like, and explain various principles and advantages, in accordance with the present disclosure, where:

FIG. 1 is a block diagram illustrating one embodiment of a computing device in accordance with various aspects set forth herein.

FIG. 2 illustrates one embodiment of a system for improved delivery of contextual data to a computing device using eye tracking technology with various aspects described herein.

FIG. 3 illustrates one embodiment of a front view of a computing device in portrait orientation with various aspects described herein.

FIG. 4 is a flowchart of one embodiment of a method for improved delivery of contextual data to a computing device using eye tracking technology with various aspects described herein.

FIG. 5 illustrates another embodiment of a front view of a computing device in portrait orientation with various aspects described herein.

FIG. 6 is a flowchart of another embodiment of a method for improved delivery of contextual data to a computing device using eye tracking technology with various aspects described herein.

FIG. 7 illustrates another embodiment of a front view of a computing device in portrait orientation with various aspects described herein.

FIG. 8 is a flowchart of another embodiment of a method for improved delivery of contextual data to a computing device using eye tracking technology with various aspects described herein.

FIG. 9 is a flowchart of another embodiment of a method for improved delivery of contextual data to a computing device using eye tracking technology with various aspects described herein.

FIG. 10 illustrates another embodiment of a front view of a computing device in portrait orientation with various aspects described herein.

FIG. 11 is a flowchart of another embodiment of a method for improved delivery of contextual data to a computing device using eye tracking technology with various aspects described herein.

FIG. 12 is a flowchart of another embodiment of a method for improved delivery of contextual data to a computing device using eye tracking technology with various aspects described herein.

FIG. 13 illustrates another embodiment of a front view of a computing device in portrait orientation with various aspects described herein.

FIG. 14 is a flowchart of one embodiment of a method for activating a window of a graphical user interface using eye tracking technology with various aspects described herein.

FIG. 15 is a flowchart of another embodiment of a method for activating a window of a graphical user interface using eye tracking technology with various aspects described herein.

### DETAILED DESCRIPTION

This disclosure provides example methods, devices (or apparatuses), systems, or articles of manufacture for improved delivery of contextual information to a computing device using eye tracking technology. By configuring a computing device in accordance with various aspects described herein, increased usability of the computing device is provided. For example, a user may use a web browser application of a smartphone to view a web page having various content. The smartphone may use its eye tracking technology to determine the user's gaze locations on its display. Further, the smartphone may use the user's gaze locations to determine a gaze duration for each of the various content on its display. The smartphone may use the gaze durations to determine a metric for each of the various content. Further, the smartphone may send the metrics to a server. The server may use the metrics to, for instance, assess the user's interests in each of the various content, rank the various content, or determine additional content to send for display on the user's smartphone.

In another example, a user may use a web browser application of a tablet computer to view a web page having various advertisements. The tablet computer may use its eye tracking technology to determine the user's gaze locations on its display. Further, the tablet computer may use the user's gaze locations to determine a gaze duration for each of the various advertisements on its display. The tablet computer may use the gaze durations to generate a metric for each of the various advertisements. Further, the tablet computer may send the metrics to a server. The server may use such metrics to, for instance, determine a fee to charge each advertiser.

In another example, a user may use a web navigation application displayed on a virtual display of a wearable device such as a pair of glasses to view a map. The wearable device may use its eye tracking technology to determine the user's gaze locations on its virtual display. The wearable device may use the user's gaze locations to determine a dwell location associated with the user being fixated on a particular location on the map. In response, the wearable device may display details such as residential roads near the dwell location on the map. While the user is fixated on the location on the map, a cursor may appear near the location, which may indicate to the user an ability to perform a complementary function such as a wink with one eye to zoom in the map or a wink with the other eye to zoom out the map.

In another example, a user may use a web browser application displayed on a display of a laptop computer to view a web page having an image of a fashion model. The laptop computer may use its eye tracking technology to determine the user's gaze locations on the display. The laptop computer may use the user's gaze locations to determine a dwell location associated with the eyes of the fashion model. In response, the laptop computer may display an advertisement of the mascara or the contact lenses the fashion model is wearing. Alternatively, the laptop computer may send the user's dwell location associated with the image of the fashion model to a server. In response, the server may send the laptop computer an advertisement or other content corresponding to the user's dwell location associated with the image of the fashion model.

In another example, a user may use a graphical user interface having multiple windows displayed on the display of a gaming system. The gaming system may use its eye tracking technology to determine the user's gaze locations on the display. The gaming system may use the user's gaze locations to determine a dwell location associated with a particular window. In response, the gaming system may activate the particular window.

In some instances, a graphical user interface (GUI) may be referred to as an object-oriented user interface, an application-oriented user interface, a web-based user interface, a touch-based user interface, or a virtual keyboard. A graphical user interface may allow a user to interact with a computing device using graphical icons, audio or visual indicators, text, images, graphics, audio, video, or the like. Further, a graphical user interface may be displayed on a display or virtual display of a computing device. A presence-sensitive input device as discussed herein, may be a device that accepts input by the proximity of a finger, a stylus or an object near the device, detects gestures without physically touching the device, or detects eye or eye lid movements or facial expressions of a user operating the device.

Additionally, a presence-sensitive input device may be combined with a display to provide a presence-sensitive display. In one example, a user may provide an input to a computing device by touching the surface of a presence-sensitive display using a finger. In another example, a user may provide input to a computing device by gesturing without physically touching any object. In another example, a gesture may be received via a digital camera, a digital video camera, or a depth camera. In another example, an eye or eye lid movement or a facial expression may be received using a digital camera, a digital video camera or a depth camera and may be processed using eye tracking technology, which may determine a gaze location on a display or a virtual display associated with a computing device. In some instances, the eye tracking technology may use an emitter operationally coupled to a computing device to produce infrared or near-infrared light for application to one or both eyes of a user of the computing device. In one example, the emitter may produce infrared or near-infrared non-collimated light. A person of ordinary skill in the art will recognize various techniques for performing eye tracking.

In some instances, a presence-sensitive display can have two main attributes. First, it may include enabling a user to interact directly with what is displayed, rather than indirectly via a pointer controlled by a mouse or touchpad. Secondly, it may include allowing a user to interact without requiring any intermediate device that would need to be held in the hand. Such displays may be attached to computers, or to networks as terminals. Such displays may also play a prominent role in the design of digital appliances such as the personal digital assistant (PDA), satellite navigation devices, mobile phones, video games, and wearable devices such as a pair of glasses having a virtual display or a watch. Further, such displays may include a capture device and a display.

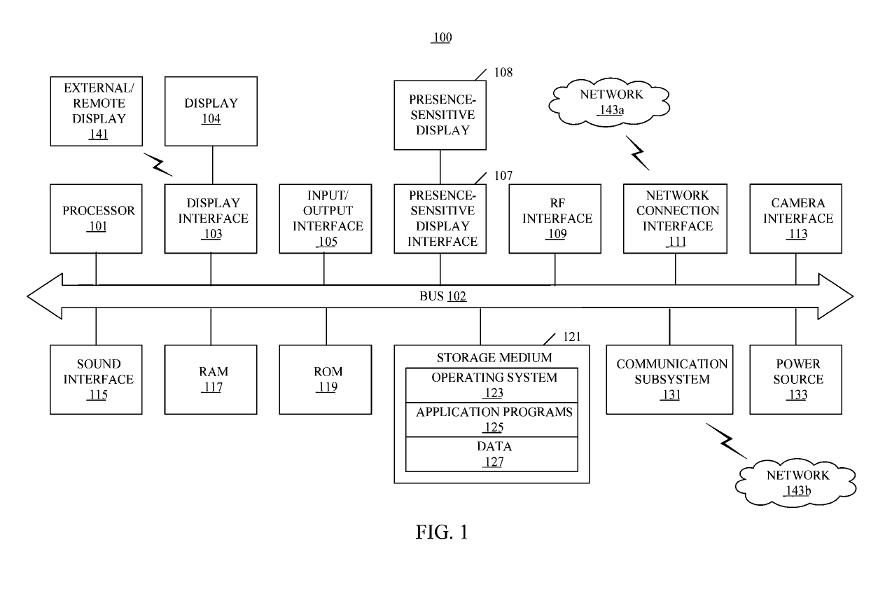

According to one example implementation, the terms computing device or mobile computing device, as used herein, may be a central processing unit (CPU), controller or processor, or may be conceptualized as a CPU, controller or processor (for example, the processor 101 of FIG. 1). In yet other instances, a computing device may be a CPU, controller or processor combined with one or more additional hardware components. In certain example implementations, the computing device operating as a CPU, controller or processor may be operatively coupled with one or more peripheral devices, such as a display, navigation system, stereo, entertainment center, Wi-Fi access point, or the like. In another example implementation, the terms computing device or mobile computing device, as used herein, may refer to a portable communication device, such as a smartphone, mobile station (MS), terminal, cellular phone, cellular handset, personal digital assistant (PDA), smartphone, wireless phone, organizer, handheld computer, desktop computer, laptop computer, tablet computer, set-top box, television, appliance, game device, medical device, display device, wearable device or some other like terminology. In one example, the computing device may output content to its local display or virtual display, or speaker(s). In another example, the computing device may output content to an external display device (e.g., over Wi-Fi) such as a TV, a virtual display of a wearable device, or an external computing device. For any example embodiment herein that may use, access or transfer privacy data, a user has the ability to opt-in or opt-out of sharing the privacy data.

FIG. 1 is a block diagram illustrating one embodiment of a computing device 100 in accordance with various aspects set forth herein. In FIG. 1, the computing device 100 may be configured to include a processor 101, which may also be referred to as a computing device, that is operatively coupled to a display interface 103, an input/output interface 105, a presence-sensitive display interface 107, a radio frequency (RF) interface 109, a network connection interface 111, a camera interface 113, a sound interface 115, a random access memory (RAM) 117, a read only memory (ROM) 119, a storage medium 121, an operating system 123, an application program 125, data 127, a communication subsystem 131, a power source 133, another element, or any combination thereof. In FIG. 1, the processor 101 may be configured to process computer instructions and data. The processor 101 may be configured to be a computer processor or a controller. For example, the processor 101 may include two computer processors. In one definition, data is information in a form suitable for use by a computer. It is important to note that a person having ordinary skill in the art will recognize that the subject matter of this disclosure may be implemented using various operating systems or combinations of operating systems.

In FIG. 1, the display interface 103 may be configured as a communication interface and may provide functions for rendering video, graphics, images, text, other information, or any combination thereof on a display 104. In one example, a communication interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof. In one example, the display interface 103 may be operatively coupled to display 104 such as a touch-screen display associated with a mobile device or a virtual display associated with a wearable device. In another example, the display interface 103 may be configured to provide video, graphics, images, text, other information, or any combination thereof for an external/remote display 141 that is not necessarily connected to the computing device. In one example, a desktop monitor may be utilized for mirroring or extending graphical information that may be presented on a mobile device. In another example, the display interface 103 may wirelessly communicate, for example, via the network connection interface 111 such as a Wi-Fi transceiver to the external/remote display 141.

In the current embodiment, the input/output interface 105 may be configured to provide a communication interface to an input device, output device, or input and output device. The computing device 100 may be configured to use an output device via the input/output interface 105. A person of ordinary skill will recognize that an output device may use the same type of interface port as an input device. For example, a USB port may be used to provide input to and output from the computing device 100. The output device may be a speaker, a sound card, a video card, a display, a monitor, a printer, an actuator, an emitter, a smartcard, another output device, or any combination thereof. In one example, the emitter may be an infrared emitter. In another example, the emitter may be an emitter used to produce infrared or near-infrared non-collimated light, which may be used for eye tracking. The computing device 100 may be configured to use an input device via the input/output interface 105 to allow a user to capture information into the computing device 100. The input device may include a mouse, a trackball, a directional pad, a trackpad, a presence-sensitive input device, a presence-sensitive display, a scroll wheel, a digital camera, a digital video camera, a web camera, a microphone, a sensor, a smartcard, and the like. The presence-sensitive input device may include a sensor, or the like to sense input from a user. The presence-sensitive input device may be combined with a display to form a presence-sensitive display. Further, the presence-sensitive input device may be coupled to the computing device. The sensor may be, for instance, a digital camera, a digital video camera, a depth camera, a web camera, a microphone, an accelerometer, a gyroscope, a tilt sensor, a force sensor, a magnetometer, an optical sensor, a proximity sensor, another like sensor, or any combination thereof. For example, the input device 115 may be an accelerometer, a magnetometer, a digital camera, a microphone, and an optical sensor.

In FIG. 1, the presence-sensitive display interface 107 may be configured to provide a communication interface to a pointing device or a presence-sensitive display 108 such as a touch screen. In one definition, a presence-sensitive display is an electronic visual display that may detect the presence and location of a touch, a gesture, an eye or eye lid movement, a facial expression or an object associated with its display area. The RF interface 109 may be configured to provide a communication interface to RF components such as a transmitter, a receiver, and an antenna. The network connection interface 111 may be configured to provide a communication interface to a network 143a. The network 143a may encompass wired and wireless communication networks such as a local-area network (LAN), a wide-area network (WAN), a computer network, a wireless network, a telecommunications network, another like network or any combination thereof. For example, the network 143a may be a cellular network, a Wi-Fi network, and a near-field network. As previously discussed, the display interface 103 may be in communication with the network connection interface 111, for example, to provide information for display on a remote display that is operatively coupled to the computing device 100. The camera interface 113 may be configured to provide a communication interface and functions for capturing digital images or video from a camera. The sound interface 115 may be configured to provide a communication interface to a microphone or speaker.

In this embodiment, the RAM 117 may be configured to interface via the bus 102 to the processor 101 to provide storage or caching of data or computer instructions during the execution of software programs such as the operating system, application programs, and device drivers. In one example, the computing device 100 may include at least one hundred and twenty-eight megabytes (128 Mbytes) of RAM. The ROM 119 may be configured to provide computer instructions or data to the processor 101. For example, the ROM 119 may be configured to be invariant low-level system code or data for basic system functions such as basic input and output (I/O), startup, or reception of keystrokes from a keyboard that are stored in a non-volatile memory. The storage medium 121 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives. In one example, the storage medium 121 may be configured to include an operating system 123, an application program 125 such as a web browser application, a widget or gadget engine or another application, and a data file 127.

In FIG. 1, the computing device 101 may be configured to communicate with a network 143b using the communication subsystem 131. The network 143a and the network 143b may be the same network or networks or different network or networks. The communication functions of the communication subsystem 131 may include data communication, voice communication, multimedia communication, short-range communications such as Bluetooth, near-field communication, location-based communication such as the use of the global positioning system (GPS) to determine a location, another like communication function, or any combination thereof. For example, the communication subsystem 131 may include cellular communication, Wi-Fi communication, Bluetooth communication, and GPS communication. The network 143b may encompass wired and wireless communication networks such as a local-area network (LAN), a wide-area network (WAN), a computer network, a wireless network, a telecommunications network, another like network or any combination thereof. For example, the network 143b may be a cellular network, a Wi-Fi network, and a near-field network. The power source 133 may be configured to provide an alternating current (AC) or direct current (DC) power to components of the computing device 100.

In FIG. 1, the storage medium 121 may be configured to include a number of physical drive units, such as a redundant array of independent disks (RAID), a floppy disk drive, a flash memory, a USB flash drive, an external hard disk drive, thumb drive, pen drive, key drive, a high-density digital versatile disc (HD-DVD) optical disc drive, an internal hard disk drive, a Blu-Ray optical disc drive, a holographic digital data storage (HDDS) optical disc drive, an external mini-dual in-line memory module (DIMM) synchronous dynamic random access memory (SDRAM), an external micro-DIMM SDRAM, a smartcard memory such as a subscriber identity module or a removable user identity (SIM/RUIM) module, other memory, or any combination thereof. The storage medium 121 may allow the computing device 100 to access computer-executable instructions, application programs or the like, stored on transitory or non-transitory memory media, to off-load data, or to upload data. An article of manufacture, such as one utilizing a communication system may be tangibly embodied in storage medium 122, which may comprise a computer-readable medium.

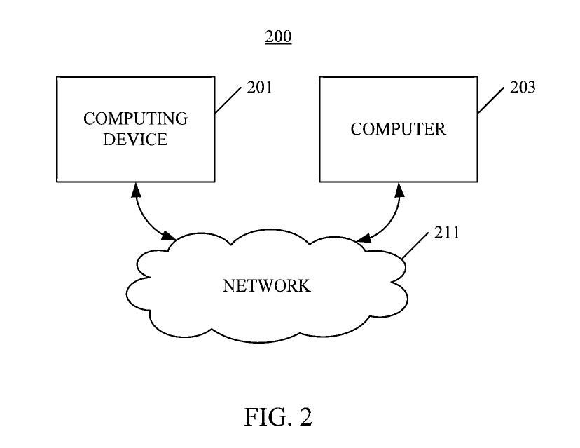

FIG. 2 illustrates one embodiment of a system 200 for improved delivery of contextual data to a computing device with various aspects described herein. In FIG. 2, the system 200 may be configured to include a computing device 201, a computer 203, and a network 211. The computer 203 may be configured to include a computer software system. In one example, the computer 203 may be a computer software system executing on a computer hardware system. The computer 203 may execute one or more services. Further, the computer 203 may include one or more computer programs running to serve requests or provide data to local computer programs executing on the computer 203 or remote computer programs executing on the computing device 201. The computer 203 may be capable of performing functions associated with a server such as a database server, a file server, a mail server, a print server, a web server, a gaming server, the like, or any combination thereof, whether in hardware or software. In one example, the computer 203 may be a web server. In another example, the computer 203 may be a file server. The computer 203 may be configured to process requests or provide data to the computing device 201 over a network 211.

In FIG. 2, the network 211 may include wired or wireless communication networks such as a local-area network (LAN), a wide-area network (WAN), a computer network, a wireless network, a telecommunications network, the like or any combination thereof. In one example, the network 211 may be a cellular network, a Wi-Fi network, and the Internet. The computing device 201 may communicate with computer 205 using the network 211. The computing device 201 may refer to a portable communication device such as a smartphone, a mobile station (MS), a terminal, a cellular phone, a cellular handset, a personal digital assistant (PDA), a wireless phone, an organizer, a handheld computer, a desktop computer, a laptop computer, a tablet computer, a set-top box, a television, an appliance, a game device, a medical device, a display device, a wearable device, or the like.

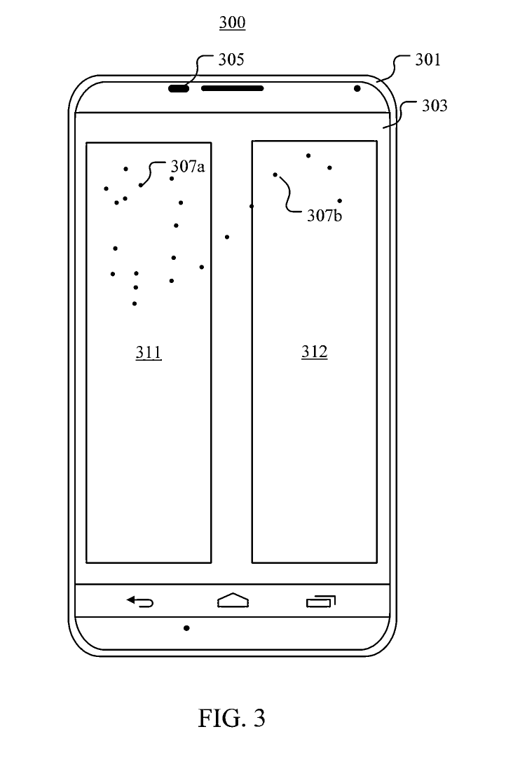

FIG. 3 illustrates one embodiment of a front view of a computing device 300 in portrait orientation with various aspects described herein. In FIG. 3, the computing device 300 may be configured to include a housing 301, a display 303 and a sensor 305. The housing 301 may be configured to house the internal components of the computing device 300 such as those described in FIG. 1 and may frame the display 303 such that the display 303 is exposed for user-interaction with the computing device 300. In one example, the display 303 may be a presence-sensitive display. The sensor 305 may be used to detect characteristics of a user of the computing device 300 such as a user's eye or eye lid movements or facial expressions or the like while the user is viewing the display 303. The sensor 305 may be, for instance, an optical sensor, a digital camera, a digital video camera, a depth camera, or the like.

In one embodiment, the computing device 300 may receive, such as from a computer, another computing device, a process of the computing device 300, memory of the computing device 300, or the like, first content and second content. In one example, each of the first content and the second content may be any content that is displayed or presented using a web browser application. In another example, each of the first content and the second content may be text, an image, video, audio, a graphic, a graphical user interface element, short message service (SMS) data, e-mail data, multimedia messaging service (MMS) data, web page content, map data, or the like. In another example, each of the first content and the second content may be advertisement data, search result data, shopping data, or the like. The computing device 300 may output, for display, the first content to a first region 311 of a graphical user interface. Further, the computing device 300 may output, for display, the second content to a second region 312 of the graphical user interface.

In the current embodiment, the computing device 300 may accumulate a first gaze duration associated with a user viewing the first region 311 of the graphical user interface. The first gaze duration may include a user's fixations or saccades associated with the first region of the graphical user interface. In one definition, a gaze may be a natural modality for indicating a user's interest. Based on the inference or determination of a plurality of gaze locations 307a and 307b, the computing device 300 may accumulate the first gaze duration. The plurality of gaze locations 307a and 307b are provided in FIG. 3 for illustrative purposes and may not be displayed on the graphical user interface during operation of the computing device 300. The computing device 300 may receive, from the sensor 305, gaze data associated with a user viewing the display 303. Further, the computing device 300 may map the gaze data to a location of the graphical user interface to determine one of the plurality of gaze locations 307a and 307b. In response to one of the plurality of gaze locations 307a and 307b being in the first region 311 of the graphical user interface, the computing device 300 may accumulate the first gaze duration.

Similarly, the computing device 300 may accumulate a second gaze duration associated with a user viewing the second region 312 of the graphical user interface 303. The second gaze duration may include a user's fixations or saccades associated with the second region of the graphical user interface. Based on the inference or determination of the plurality of gaze locations 307a and 307b, the computing device 300 may accumulate the second gaze duration. In response to one of the plurality of gaze locations 307a and 307b being in the second region 312 of the graphical user interface, the computing device 300 may accumulate the second gaze duration. The first gaze duration and the second gaze duration may be accumulated over a predetermined time associated with a time sufficient to quantify a user's interest in viewing content. A person of ordinary skill in the art will recognize various techniques for quantifying a user's interest in viewing content. The computing device 300 may also determine statistical data associated with the first gaze duration or the second gaze duration. The statistical data may include, for instance, an average, a moving average, a standard deviation, a variance, a moment, the like, or any combination thereof. Further, the statistical data may be determined using, for instance, gaze data, a gaze location, a gaze duration, the like, or any combination thereof.

In this embodiment, the computing device 300 may determine a first metric associated with the first content and a second metric associated with the second content using the first gaze duration and the second gaze duration. The first metric may be associated with a user's interest in the first content. Similarly, the second metric may be associated with a user's interest in the second content. The computing device 300 may determine each of the first metric and the second metric using the statistical data associated with the first gaze duration and the second gaze duration. In one example, the computing device 300 may determine the first metric using the first gaze duration and the second gaze duration such as by dividing the first gaze duration by the sum of the first gaze duration and the second gaze duration. In another example, the first metric may be the first gaze duration and the second metric may be the second gaze duration. In another example, the computing device 300 may determine the first metric by dividing the first gaze duration by the predetermined time. A person of ordinary skill in the art will recognize various techniques for determining metrics associated with quantifying a user's interest in particular content. The computing device 300 may send, to the computer, the first metric and the second metric.

In another embodiment, the computing device 300 may accumulate a viewing duration corresponding to an amount of time that a user views the display 303. The computing device 300 may initiate an accumulation of the viewing duration responsive to outputting, for display, the first content or the second content. Further, the computing device 300 may accumulate the viewing duration responsive to, for instance, receiving gaze data, receiving an indication that a user is viewing the display 303, or the like. The computing device 300 may determine the first metric or the second metric responsive to the viewing duration being a minimum viewing duration such as a duration sufficient to quantify a user's interest in viewing content.

In another embodiment, the computing device 300 may determine the first metric and the second metric using the viewing duration. In one example, the computing device 300 may determine the first metric by dividing the first gaze duration by the viewing duration.

In another embodiment, the computing device 300 may initiate the accumulation of the viewing duration upon receiving initial gaze data and outputting, for display, the first content or the second content.

In another embodiment, the computing device 300 may determine a non-viewing time corresponding to an amount of time that a user does not view the display 303. The computing device 300 may determine the first metric or the second metric responsive to the non-viewing time being a non-viewing time threshold associated with a time sufficient to determine that a user is no longer viewing the display 303. A person of ordinary skill in the art will recognize various techniques for determining when a user is viewing or not viewing a display. For example, the computing device 300 may determine the non-viewing time responsive to not receiving gaze data, receiving an indication that a user is not viewing the display 303, or the like.

In another embodiment, the computing device 300 may place the display 303 into a lower power mode in response to the non-viewing time being at least a non-viewing time threshold associated with a time sufficient to determine that a user is no longer viewing the display 303. In one example, the lower power mode may be associated with reducing a brightness of the display 303. The computing device 300 may remove the display 303 from the lower power mode responsive to receiving, from the sensor 305, gaze data associated with a user of the computing device 300 viewing the display 303, receiving an indication that a user is viewing the display 303, or the like.

In another embodiment, the computing device 300 may reduce a duty cycle of the sensor 305 in response to the non-viewing time being at least a non-viewing time threshold associated with an amount of time sufficient to determine that a user is no longer viewing the display 303. The computing device 300 may increase the duty cycle of the sensor 305 in response to receiving gaze data from the sensor 305 associated with a user of the computing device viewing the display 303, receiving an indication that a user is viewing the display 303, or the like.

In another embodiment, the computing device 300 may include an emitter used to produce infrared or near-infrared light for use by eye tracking technology. In one example, the emitter may produce infrared or near-infrared non-collimated light. The emitter may be on the front of the computing device 300 and housed by the housing 301. In one example, a plurality of emitters may be associated with two or more corners of the front of the computing device 300.

In another embodiment, the computing device 300 may store the first metric or the second metric to a log file. In one example, the computing device 300 may send, to a computer, the log file. In another example, the computing device 300 may receive, from a computer, a request for the log file. In response to the request, the computing device 300 may send, to the computer, the log file.

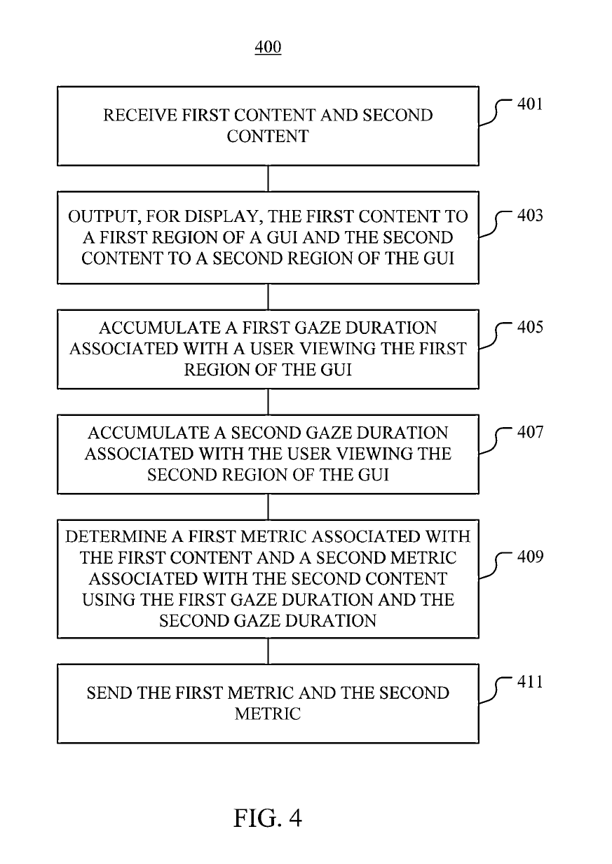

FIG. 4 is a flowchart of one embodiment of a method 400 for improved delivery of contextual data to a computing device using eye tracking technology with various aspects described herein. In FIG. 4, the method 400 may begin, for instance, at block 401, where it may include receiving first content and second content such as from a computer, another computing device, a process of the computing device, memory of the computing device, or the like. At block 403, the method 400 may include outputting, for display, the first content to a first region of a graphical user interface and the second content to a second region of the graphical user interface. At block 405, the method 400 may include accumulating a first gaze duration associated with a user viewing the first region of the graphical user interface. At block 407, the method 400 may include accumulating a second gaze duration associated with a user viewing the second region of the graphical user interface. At block 409, the method 400 may include determining a first metric associated with the first content and a second metric associated with the second content using the first gaze duration and the second gaze duration. At block 411, the method 400 may include sending the first metric and the second metric such as to a computer, another computing device, a process of the computing device, memory of the computing device, or the like.

In another embodiment, a method may include receiving, from a sensor, gaze data associated with a user of a computing device viewing a display associated with the computing device. Further, the method may include mapping the gaze data to a gaze location of the graphical user interface. In response to the gaze location being in the first region of the graphical user interface, the method may include accumulating the first gaze duration.

In another embodiment, a method may include receiving, from a sensor, gaze data associated with a user of a computing device viewing a display associated with the computing device. Further, the method may include mapping the gaze data to a gaze location of the graphical user interface. In response to the gaze location being in the second region of the graphical user interface, the method may include accumulating the second gaze duration.

In another embodiment, a method may include accumulating a viewing duration corresponding to an amount of time that a user views a display associated with a computing device. Further, the method may include determining the first metric and the second metric responsive to the viewing duration being at least a minimum viewing duration.

In another embodiment, a method may include receiving, from a sensor, gaze data associated with a user of a computing device viewing a display associated with the computing device. In response to receiving the gaze data, the method may include accumulating a viewing duration.

In another embodiment, a method may begin accumulating a viewing duration responsive to outputting at least one of first content and second content.

In another embodiment, a method may include determining a first metric and a second metric using a viewing duration.

In another embodiment, a method may include determining a non-viewing time corresponding to an amount of time that a user does not view a display associated with the computing device. Further, the method may include determining a first metric and a second metric responsive to the non-viewing time being at least a minimum non-viewing time.

In another embodiment, a method may include accumulating the first gaze duration and the second gaze duration over a predetermined time associated with an amount of time sufficient to quantify a user's interest in viewing particular content.

In another embodiment, a method may include determining the first metric and the second metric using a predetermined time associated with an amount of time sufficient to quantify a user's interest in viewing particular content.

In another embodiment, a method may include removing, from display, the second content in the second region of the graphical user interface.

In another embodiment, each of the first content and the second content may be a search result.

In another embodiment, each of the first content and the second content may be an advertisement.

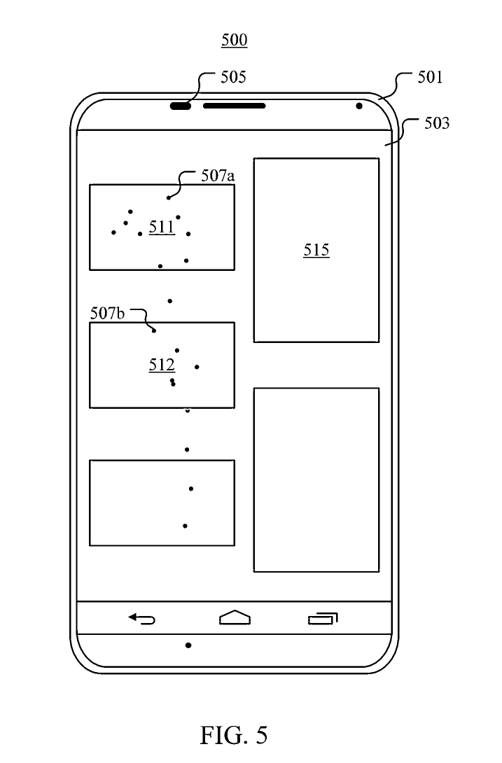

FIG. 5 illustrates one embodiment of a front view of a computing device 500 in portrait orientation with various aspects described herein. In FIG. 5, the computing device 500 may be configured to include a housing 501, a display 503 and a sensor 505. The housing 501 may be configured to house the internal components of the computing device 500 such as those described in FIG. 1 and may frame the display 503 such that the display 503 is exposed for user-interaction with the computing device 500. The sensor 505 may be used to detect characteristics of a user of the computing device 500 such as a user's eye or eye lid movements, a user's facial expressions or the like while a user is viewing the display 503 of the computing device 500. The sensor 505 may be, for instance, an optical sensor, a digital camera, a digital video camera, a depth camera, or the like.

In one embodiment, the computing device 500 may receive, such as from a computer, another computing device, a process of the computing device 500, memory of the computing device 500 or the like, first content and second content. The computing device 500 may output, for display, the first content to a first region 511 of the graphical user interface. Further, the computing device 500 may output, for display, the second content to a second region 512 of the graphical user interface. Based on the inference or determination of a plurality of gaze locations 507a and 507b, the computing device 500 may accumulate a first gaze duration. The plurality of gaze locations 507a and 507b are provided in FIG. 5 for illustrative purposes and may not be displayed on the graphical user interface during operation of the computing device 500. The computing device 500 may receive, from the sensor 505, gaze data associated with a user viewing the display 503. Further, the computing device 500 may map the gaze data to a location of the graphical user interface to determine one of the plurality of gaze locations 507a and 507b. In response to one of the plurality of gaze locations 507a and 507b being in the first region 511 of the graphical user interface, the computing device 500 may accumulate the first gaze duration. Similarly, the computing device 500 may accumulate a second gaze duration associated with a user viewing the second region 512 of the graphical user interface. Based on the inference or determination of the plurality of gaze locations 507a and 507b, the computing device 500 may accumulate a second gaze duration. In response to a portion of the plurality of gaze locations 507a and 507b being in the second region 512 of the graphical user interface, the computing device 500 may accumulate the second gaze duration.

In the current embodiment, the computing device 500 may determine a first metric associated with the first content and a second metric associated with the second content using the first gaze duration and the second gaze duration. The computing device 500 may send, to the computer, the first metric and the second metric. In response to sending the first metric and the second metric, the computing device 500 may receive, from the computer, third content. The third content may be associated with the first metric or the second metric. In one example, the third content may be any content that is displayed or presented using a web browser application. In another example, the third content may be text, an image, video, audio, graphics, a graphical user interface element, SMS data, e-mail data, MMS data, web page content, map data, the like or any combination thereof. In another example, the third content may be advertisement data, search result data, shopping data, the like, or any combination thereof. The computing device 500 may output, for display, the third content to, for instance, the first region 511, the second region 512, a third region 515, or elsewhere.

In another embodiment, the computing device 500 may output the third content to the second region 512 of the graphical user interface in response to the first metric of the first region 511 of the graphical user interface being at least the second metric of the second region 512 of the graphical user interface.

In another embodiment, in response to the first metric of the first region 511 of the graphical user interface being at least the second metric of the second region 512 of the graphical user interface, the computing device 500 may output the third content to the first region 511 of the graphical user interface. Further, the computing device 500 may remove, from display, any content associated with the second region 512 of the graphical user interface.

In another embodiment, the computing device 500 may output, for display, the third content to a third region 515 of the graphical user interface.

In another embodiment, the computing device 500 may rank the first content and the second content using the first gaze duration and the second gaze duration. Further, the first metric and the second metric may represent a rank of the first content and a rank of the second content, respectively.

In another embodiment, the first content may be a first advertisement and the second content may be a second advertisement. Further, the third content may be a shopping item, a third advertisement or other content associated with at least one of the first content and the second content.

In another embodiment, the first content may be a first shopping item and the second content may be a second shopping item. Further, the third content may be a third shopping item, an advertisement or other content associated with at least one of the first content and the second content.

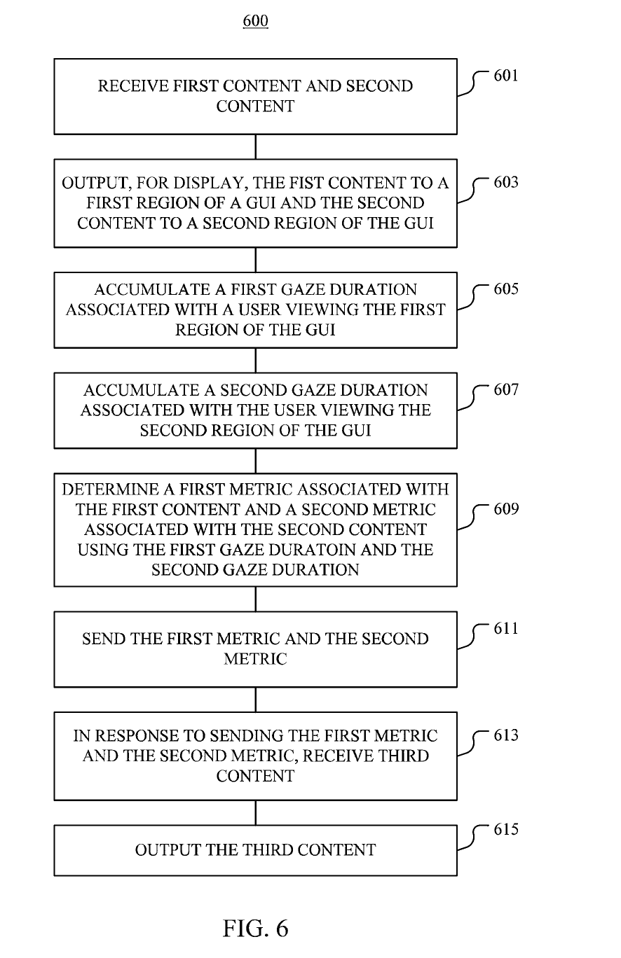

FIG. 6 is a flowchart of another embodiment of a method 600 for improved delivery of contextual data to a computing device using eye tracking technology with various aspects described herein. In FIG. 6, the method 600 may begin, for instance, at block 601, where it may include receiving first content and second content such as from a computer, another computing device, a process of the computing device, memory of the computing device, or the like. At block 603, the method 600 may output, for display, the first content to a first region of a graphical user interface and the second content to a second region of the graphical user interface. At block 605, the method 600 may accumulate a first gaze duration associated with a user viewing the first region of the graphical user interface. At block 607, the method 600 may accumulate a second gaze duration associated with a user viewing the second region of the graphical user interface. At block 609, the method 600 may determine a first metric associated with the first content and a second metric associated with the second content using the first gaze duration and the second gaze duration. At block 611, the method 600 may send the first metric and the second metric such as to a computer, another computing device, a process of the computing device, memory of the computing device, or the like. In response to sending the first metric and the second metric, at block 613, the method 600 may receive the third content such as from a computer, another computing device, a process of the computing device, another computing device, memory of the computing device, or the like. At block 615, the method 600 may output, for display, the third content.

In another embodiment, a method may include receiving the third content responsive to sending the first metric and the second metric. Further, the method may include outputting, for display, the third content.

In another embodiment, a method may, in response to the first metric being at least the second metric, output, for display, the third content to the second region of the graphical user interface.

In another embodiment, a method may, in response to the first metric being at least the second metric, output, for display, the third content to the first region of the graphical user interface.

In another embodiment, a method may include outputting the third content to the third region of the graphical user interface.

In another embodiment, the third content may be associated with the first content.

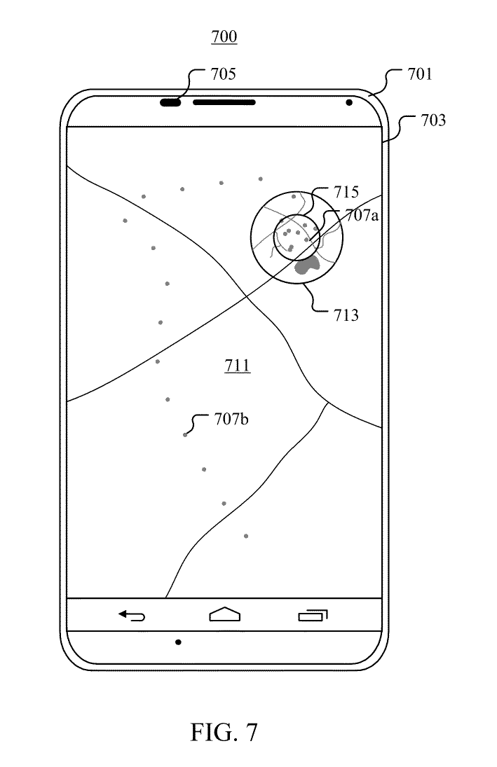

FIG. 7 illustrates another embodiment of a front view of a computing device 700 in portrait orientation with various aspects described herein. In FIG. 7, the computing device 700 may be configured to include a housing 701, a display 703 and a sensor 705. The housing 701 may be configured to house the internal components of the computing device 700 such as those described in FIG. 1 and may frame the display 703 such that the display 703 is exposed for user-interaction with the computing device 700. The sensor 705 may be used to detect characteristics of a user of the computing device 700 such as the user's eye or eye lid movements, the user's facial expressions or the like while the user is viewing the display 703 of the computing device 700. The sensor 705 may be, for instance, an optical sensor, a digital camera, a digital video camera, a depth camera, or the like.

In one embodiment, the computing device 700 may receive, such as from a computer, another computing device, a process of the computing device 700, memory of the computing device 700, or the like, first content and second content. In one example, the first content may be generalized map data and the second content may be detailed map data. The generalized map data may include, for instance, major roads or highways such as interstate highways, major cities or towns, major lakes or rivers, or the like. The detailed map data may include, for instance, minor roads or highways such as residential roads, minor cities or towns, minor lakes or rivers, or the like. In another example, the first content may be associated with a first set of characteristics of a particular symbolic depiction and the second content may be associated with a second set of characteristics of the particular symbolic depiction. A person of ordinary skill in the art will recognize various techniques for mapping data. Further, the computing device 700 may output, for display, the first content to a first region 711 of the graphical user interface.

In this embodiment, the computing device 700 may determine a first dwell time associated with a user viewing a first dwell location 715 of the graphical user interface. Based on the inference or determination of a plurality of gaze locations 707a and 707b, the computing device 700 may determine the first dwell time and the first dwell location 715. The plurality of gaze locations 707a and 707b are provided in FIG. 7 for illustrative purposes and may not be displayed on the graphical user interface during operation of the computing device 700. The computing device 700 may receive, from the sensor 705, gaze data associated with a user viewing the display 703. Further, the computing device 700 may map the gaze data to a location of the graphical user interface to determine one of the plurality of gaze locations 707a and 707b. In response to a portion of the plurality of gaze locations 707a and 707b being associated with the first dwell location 715 of the graphical user interface, the computing device 700 may determine the first dwell time. The first dwell time may correspond to a user's fixation associated with the first dwell location 715 of the graphical user interface. In one example, the first dwell time may correspond to an amount of time a user's gaze location is associated with the first dwell location 715 of the graphical user interface. In another example, an area of the first dwell location 715 may be a predetermined area. In another example, an area of the first dwell location 715 may be an area sufficient to determine a user's fixation. A person of ordinary skill in the art will recognize various techniques for determining a dwell location and a dwell time.

Furthermore, in response to determining that the first dwell time is at least a minimum dwell time, the computing device 700 may determine a first sub-region 713 of the graphical user interface associated with the first dwell location 715 of the graphical user interface. The first region 711 may include the first sub-region 713. The minimum dwell time may be associated with an amount of time sufficient to determine a user's fixation on a dwell location of the graphical user interface. In one example, the minimum dwell time may be in the range of one hundred milliseconds to two seconds. Further, the minimum dwell time may be modified based on, for instance, the type of content displayed, the type of eye or eye lid movements of a user of the computing device 700 such as sporadic fixations or random searching. In one example, an area of the first sub-region 713 may be at least an area of the first dwell location 715. In another example, an area of the first sub-region 713 may correspond to a user's gaze locations associated with the first dwell location 715. In another example, an area of the first sub-region 713 may be a predetermined area. The computing device 700 may determine a first portion of the second content to display in the first sub-region 713 of the graphical user interface. The computing device 700 may output, for display, the first portion of the second content to the first sub-region 713 of the graphical user interface.

In another embodiment, the computing device 700 may determine a second dwell time corresponding to a user viewing a second dwell location associated with the first region 711 of the graphical user interface. In response to determining that the second dwell time is at least the minimum dwell time, the computing device 700 may determine a second sub-region of the graphical user interface associated with the second dwell location of the graphical user interface. The first region 711 may include the second sub-region. The computing device 700 may determine a second portion of the second content to display in the second sub-region of the graphical user interface. The computing device 700 may output, for display, the second portion of the second content to the second sub-region of the graphical user interface.

In another embodiment, the computing device 700 may remove, from display, the first portion of the second content from the first sub-region 713 of the graphical user interface responsive to outputting the second portion of the second content to the second sub-region of the graphical user interface.

In another embodiment, the computing device 700 may change a transparency of the first portion of the second content over a predetermined time such in a range of one (1) second to sixty (60) seconds.

In another embodiment, the computing device 700 may receive, from a sensor, gaze data associated with a user of the computing device 700 viewing the display 703. Further, the computing device 700 may map the gaze data to a location of the graphical user interface to determine a gaze location. While the gaze location is associated with the first dwell location 715 of the graphical user interface, the computing device 700 may accumulate the first dwell time.

In another embodiment, an area of the first sub-region 713 is at least an area of the first dwell location 715.

In another embodiment, the computing device 700 may adjust a size of a first portion of the first content associated with the first sub-region 713 of the graphical user interface by an adjustment factor to generate an adjusted first portion of the first content. Further, the computing device 700 may adjust a size of the first portion of the second content associated with the first sub-region 713 of the graphical user interface by the adjustment factor to generate an adjusted first portion of the second content. The computing device 700 may output, for display, the adjusted first portion of the first content and the adjusted first portion of the second content to the first sub-region 713 of the graphical user interface.

In another embodiment, the computing device 700 may adjust a size of the first sub-region 713 by the adjustment factor.

In another embodiment, the computing device 700 may receive an indication of a first action. In one example, the first action may be zooming in the first content of the graphical user interface centered on the first dwell location 715. In another example, the indication of the first action may be associated with a user winking with the left eye.

In another embodiment, the computing device 700 may receive an indication of a second action. In one example, the second action may be opposite to the first action. In another example, the second action may be zooming out the first content of the graphical user interface centered on the first dwell location 715. In another example, the indication of the second action may be associated with a user winking with the right eye.

In another embodiment, the computing device 700 may output, for display, an indicator associated with the first dwell location 715 of the graphical user interface responsive to determining that the first dwell time is at least the minimum dwell time. In one example, the indicator may be a cursor, a magnifying glass, or the like. In another example, the indicator may indicate to a user of the computing device 700 the user's point of fixation on the graphical user interface.

In another embodiment, the computing device 700 may increase a transparency of the indicator associated with the first dwell location 715 responsive to the gaze location being associated with the first dwell location 715.

In another embodiment, the computing device 700 may decrease a transparency of the indicator associated with the first dwell location 715 responsive to the gaze location not being associated with the first dwell location 715.

In another embodiment, while the indicator is displayed, the computing device 700 may perform a first action responsive to receiving an indication of the first action. The display of the indicator may provide a cue to a user that the first action may be performed while the indicator is displayed. In one example, the first action may be zooming in the first content of the graphical user interface centered on the first dwell location 715. In another example, the indication of the first action may be associated with a user performing a wink with his or her left eye.

In another embodiment, while the indicator is displayed, the computing device 700 may perform a second action responsive to receiving an indication of a second action. In one example, the second action may be opposite to the first action. In another example, the second action may be zooming out the first content of the graphical user interface centered on the first dwell location 715. In another example, the indication of the second action may be associated with a user performing a wink with his or her right eye.

In another embodiment, the computing device 700 may overlay the first portion of the second content on the first content.

In another embodiment, the computing device 700 may determine a transparency of the first portion of the second content.

In another embodiment, the computing device 700 may increase a transparency of the first portion of the second content while the gaze location is associated with the first dwell location 715 of the graphical user interface. For example, while a user is fixated on the first dwell location 715, the transparency of the first portion of the second content increases.

In another embodiment, the computing device 700 may decrease a transparency of the first portion of the second content while the gaze location is not associated with the first dwell location 715 of the graphical user interface. For example, while a user is not fixated on the first dwell location 715, the transparency of the first portion of the second content decreases.

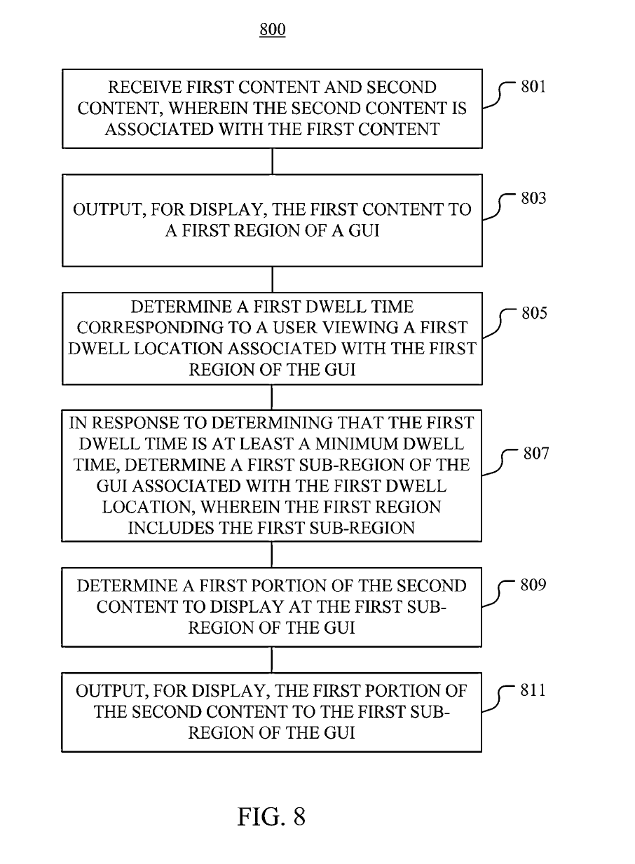

FIG. 8 is a flowchart of another embodiment of a method 800 for improved delivery of contextual data to a computing device using eye tracking technology with various aspects described herein. In FIG. 8, the method 800 may begin, for instance, at block 801, where it may include receiving, at the computing device, first content and second content. At block 803, the method 800 may output, for display, the first content to a graphical user interface of the computing device. At block 805, the method 800 may determine a first dwell time associated with a user viewing a first dwell location of the graphical user interface. In response to determining that the first dwell time is at least a minimum dwell time, at block 807, the method 800 may determine a first region of the graphical user interface associated with the first dwell location of the graphical user interface. At block 809, the method 800 may determine a first portion of the second content to display at the first region of the graphical user interface. At block 811, the method 800 may output, for display, the first portion of the second content to the first region of the graphical user interface.

In another embodiment, the first content may be associated with generalized map data.

In another embodiment, the generalized map data may include an interstate highway.

In another embodiment, the second content may be associated with detailed map data.

In another embodiment, the detailed map data may include a residential road.

In another embodiment, the first content may be associated with a first set of characteristics of a particular symbolic depiction.

In another embodiment, the second content may be associated with a second set of characteristics of a particular symbolic depiction.

In another embodiment, a method may include outputting the first portion of the second content to the first sub-region of the graphical user interface by increasing a transparency of the first portion of the second content over a predetermined time such as in the range of one second to one minute.

In another embodiment, a method may include receiving, from a sensor, gaze data corresponding to a user of the computing device viewing the display associated with the computing device. Further, the method may include mapping the gaze data to a location of the graphical user interface to determine a gaze location. While the gaze location is associated with the first dwell location of the graphical user interface, the method may include accumulating the first dwell time.

In another embodiment, an area of the first sub-region may be at least an area of the first dwell location.

In another embodiment, a method may include determining a first portion of the first content associated with the first sub-region of the graphical user interface. The method may include adjusting a size of the first portion of the first content by an adjustment factor to generate an adjusted first portion of the first content. Further, the method may include adjusting the first portion of the second content by the adjustment factor to generate an adjusted first portion of the second content. The method may include outputting, for display, the adjusted first portion of the first content and the adjusted first portion of the second content to the first sub-region of the graphical user interface.

In another embodiment, a method may include adjusting a size of the first sub-region by the adjustment factor to generate an adjusted first sub-region. Further, the method may include outputting, for display, the adjusted first portion of the first content and the adjusted first portion of the second content to the adjusted first sub-region of the graphical user interface.

In another embodiment, a method may include outputting the first portion of the second content to the first sub-region of the graphical user interface by overlaying the first portion of the second content on the first content.

In another embodiment, a method may include outputting the first portion of the second content to the first sub-region of the graphical user interface by increasing the transparency of the first portion of the second content responsive to the gaze location being associated with the first dwell location of the graphical user interface.

In another embodiment, a method may include outputting the first portion of the second content to the first sub-region of the graphical user interface by decreasing the transparency of the first portion of the second content responsive to the gaze location not being associated with the first dwell location of the graphical user interface.

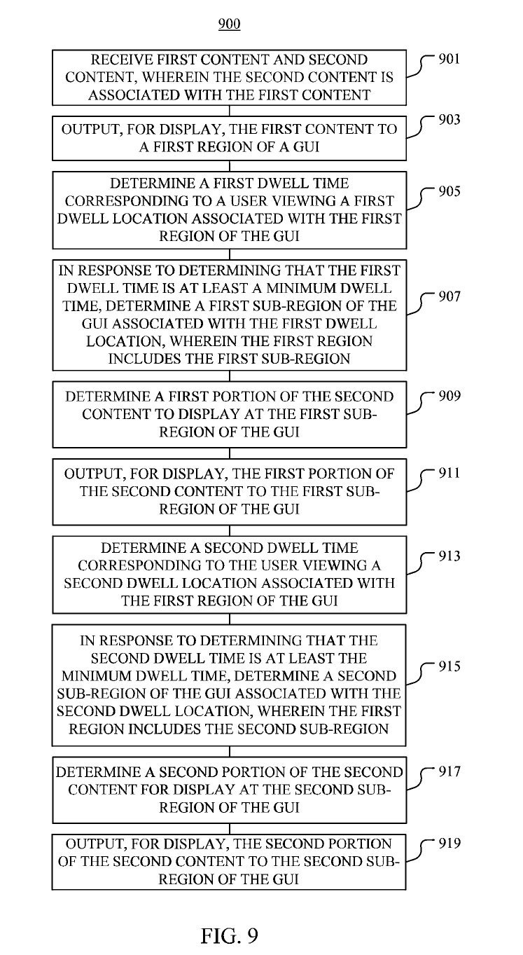

FIG. 9 is a flowchart of another embodiment of a method 900 for improved delivery of contextual data to a computing device using eye tracking technology with various aspects described herein. In FIG. 9, the method 900 may begin, for instance, at block 901, where it may include receiving, at the computing device, first content and second content. At block 903, the method 900 may output, for display, the first content to a graphical user interface of the computing device. At block 905, the method 900 may determine a first dwell time associated with a user viewing a first dwell location of the graphical user interface. In response to determining that the first dwell time is at least a minimum dwell time, at block 907, the method 900 may determine a first region of the graphical user interface associated with the first dwell location of the graphical user interface. At block 909, the method 900 may determine a first portion of the second content to display associated with the first region of the graphical user interface. At block 911, the method 900 may output, for display, the first portion of the second content to the first region of the graphical user interface. At block 913, the method 900 may determine a second dwell time associated with a user viewing a second dwell location of the graphical user interface. In response to determining that the second dwell time is at least the minimum dwell time, at block 915, the method 900 may determine a second region of the graphical user interface associated with the second dwell location of the graphical user interface. At block 917, the method 900 may determine a second portion of the second content for display at the second region of the graphical user interface. At block 919, the method 900 may output, for display, the second portion of the second content to the second region of the graphical user interface.

In another embodiment, a method may include determining a second dwell time associated with a user viewing a second dwell location of the graphical user interface. In response to determining that the second dwell time is at least the minimum dwell time, the method may include determining a second sub-region of the graphical user interface associated with the second dwell location. The first region may include the second sub-region. The method may include determining a second portion of the second content associated with the second sub-region of the graphical user interface. Further, the method may include outputting, for display, the second portion of the second content to the second sub-region of the graphical user interface.

In another embodiment, a method may include removing, from display, the first portion of the second content from the first sub-region of the graphical user interface.

In another embodiment, a method may include removing the first portion of the second content from the first sub-region of the graphical user interface by decreasing a transparency of the first portion of the second content over a predetermined time.

In another embodiment, the first sub-region of the graphical user interface and the second sub-region of the graphical user interface may overlap.

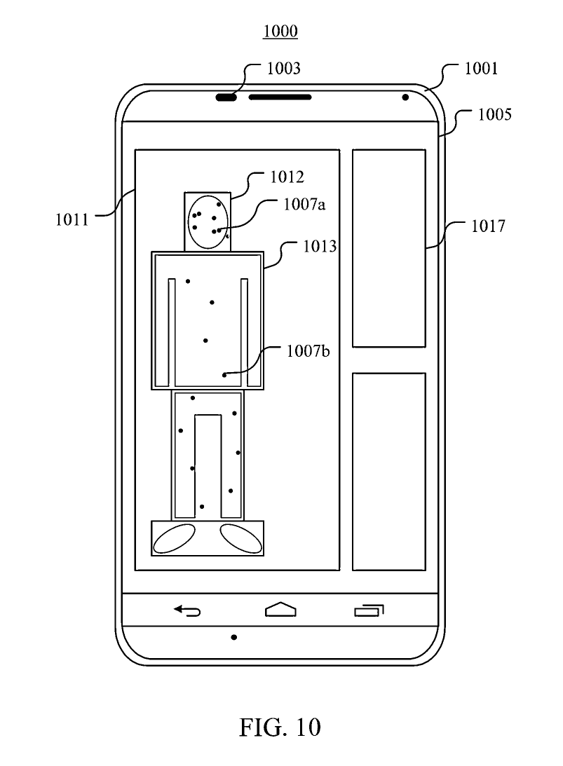

FIG. 10 illustrates another embodiment of a front view of a computing device 1000 in portrait orientation with various aspects described herein. In FIG. 10, the computing device 1000 may be configured to include a housing 1001, a display 1003 and a sensor 1005. The housing 1001 may be configured to house the internal components of the computing device 1000 such as those described in FIG. 1 and may frame the display 1003 such that the display 1003 is exposed for user-interaction with the computing device 1000. The sensor 1005 may be used to detect characteristics of a user of the computing device 1000 such as a user's eye or eye lid movements, a user's facial expressions or the like while a user is viewing the graphical user interface 1003 of the computing device 1000. The sensor 1005 may be, for instance, an optical sensor, a digital camera, a digital video camera, a depth camera, or the like.

In one embodiment, the computing device 1000 may receive, such as from a computer, another computing device, a process of the computing device 1000, memory of the computing device 1000, or the like, first content. Further, the computing device 1000 may output, for display, the first content to a first region 1011 of the graphical user interface. The first region 1011 may include a first sub-region 1012 and a second sub-region 1013. The first sub-region 1012 may include a first portion of the first content. Also, the second sub-region 1013 may include a second portion of the first content. In one example, the first region 1011 may include an image of a shopping item with the first sub-region 1012 associated with a first portion of the shopping item and the second sub-region associated 1013 with a second portion of the shopping item. In another example, the first region 1011 may include an image of a fashion model with the first sub-region 1012 associated with the face of the fashion model and the second sub-region 1013 associated with the torso of the fashion model. In another example, the first region 1011 may include an advertisement with the first sub-region 1012 associated with a first portion of the advertisement and the second sub-region 1013 associated with a second portion of the advertisement.

In this embodiment, the computing device 1000 may determine a first dwell time corresponding to a user viewing a first dwell location associated with the first sub-region 1012 of the graphical user interface. Based on the inference or determination of a plurality of gaze locations 1007a and 1007b, the computing device 1000 may determine the first dwell time and the first dwell location. The plurality of gaze locations 1007a and 1007b are provided in FIG. 10 for illustrative purposes and may not be displayed on the graphical user interface during operation of the computing device 1000. The computing device 1000 may receive, from the sensor 1005, gaze data associated with a user viewing the display 1003. Further, the computing device 1000 may map the gaze data to a location of the graphical user interface to determine one of the plurality of gaze locations 1007a and 1007b. In response to a portion of the plurality of gaze locations 1007a and 1007b corresponding to the first dwell location associated with the first sub-region 1012 of the graphical user interface, the computing device 1000 may determine the first dwell time. The first dwell time may be associated with a user's fixation on the first dwell location of the graphical user interface.

Furthermore, in response to determining that the first dwell time is at least a minimum dwell time, the computing device 1000 may output, for display, second content to a second region 1017 of the graphical user interface. The second content may be associated with the first portion of the first content displayed in the first sub-region 1012. In one example, the first portion of the first content may be a first portion of an advertisement and the second content may be a shopping item associated with the first portion of the advertisement. In another example, the first portion of the first content may be a face of a fashion model and the second content may be an advertisement associated with a type of make-up the fashion model is wearing. In another example, the first portion of the first content may be a first portion of a shopping item and the second content may be an advertisement associated with the first portion of the shopping item. In another example, the first portion of the first content may be a first portion of a first shopping item and the second content may be a second shopping item associated with the first portion of the first shopping item. In another example, the first portion of the first content may be a first portion of a first advertisement and the second content may be a second advertisement associated with the first portion of the first advertisement.

In another embodiment, the computing device 1000 may receive, such as from a computer, another computing device, a process of the computing device 1000, memory of the computing device 1000 or the like, first content. Further, the computing device 1000 may output, for display, the first content to a first region 1011 of the graphical user interface. The first region 1011 may include a first sub-region 1012 and a second sub-region 1013. The first sub-region 1012 may include a first portion of the first content. Also, the second sub-region 1013 may include a second portion of the first content. The computing device 1000 may accumulate a first gaze duration associated with a user viewing the first sub-region 1012 of the graphical user interface.

Furthermore, the computing device 1000 may accumulate a second gaze duration associated with a user viewing the second sub-region 1013 of the graphical user interface. Based on the inference or determination of the plurality of gaze locations 1007a and 1007b, the computing device 1000 may accumulate the first gaze duration and the second gaze duration. The computing device 1000 may receive, from the sensor 1005, gaze data associated with a user viewing the display 1003. Further, the computing device 1000 may map the gaze data to a location of the graphical user interface to determine the plurality of gaze locations 1007a and 1007b. In response to one of the plurality of gaze locations 1007a and 1007b being in the first sub-region 1012 of the graphical user interface, the computing device 1000 may accumulate the first gaze duration. Similarly, the computing device 1000 may accumulate a second gaze duration associated with a user viewing the second sub-region 1013 of the graphical user interface. In response to one of the plurality of gaze locations 1007a and 1007b being in the second sub-region 1013 of the graphical user interface, the computing device 1000 may accumulate the second gaze duration. In response to determining that the first gaze duration is at least the second gaze duration, the computing device 1000 may output, for display, second content to a second region 1017 of the graphical user interface. The second content may be associated with the first portion of the first content displayed in the first sub-region 1012 of the graphical user interface.

In another embodiment, the computing device 1000 may receive, from a computer, the second content.

In another embodiment, the computing device 1000 may send, to the computer, a request for the second content. Further, in response to the request, the computing device 1000 may receive, from the computer, the second content.

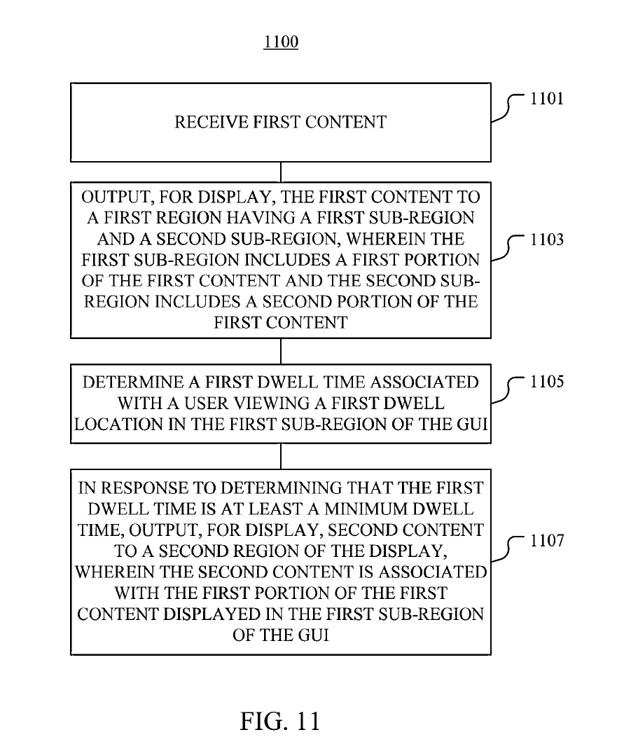

FIG. 11 is a flowchart of another embodiment of a method 1100 for improved delivery of contextual data using eye tracking technology to a computing device with various aspects described herein. In FIG. 11, the method 1100 may begin, for instance, at block 1101, where it may include receiving, at the computing device, first content such as from a computer, another computing device, a process of the computing device, memory of the computing device, or the like. At block 1103, the method 1100 may output, for display, the first content to a first region having a first sub-region and a second sub-region. The first sub-region may include a first portion of the first content. Further, the second sub-region may include a second portion of the first content. At block 1105, the method 1100 may determine a first dwell time corresponding to a user viewing a first dwell location associated with the first sub-region. In response to determining that the first dwell time is at least a minimum dwell time, at block 1107, the method 1100 may output, for display, second content to a second region of the graphical user interface. The second content may be associated with the first portion of the first content displayed in the first sub-region of the graphical user interface.

In another embodiment, a method may include receiving, from a sensor, gaze data associated with a user of the computing device viewing a display associated with the computing device. Further, the method may include mapping the gaze data to a location of the graphical user interface to determine a gaze location. While the gaze location corresponds to the first dwell location associated with the first sub-region, the method may include accumulating the first dwell time.

In another embodiment, a method may include receiving, from the computer, the second content.

In another embodiment, a method may include sending, to the computer, a request for the second content. In response to the request, the method may include receiving, from the computer, the second content. In one example, the request for the second content may include the first dwell location associated with the first content.

In another embodiment, the first content may be a shopping item and the second content may be an advertisement.

In another embodiment, the first content may be an advertisement and the second content may be a shopping item.

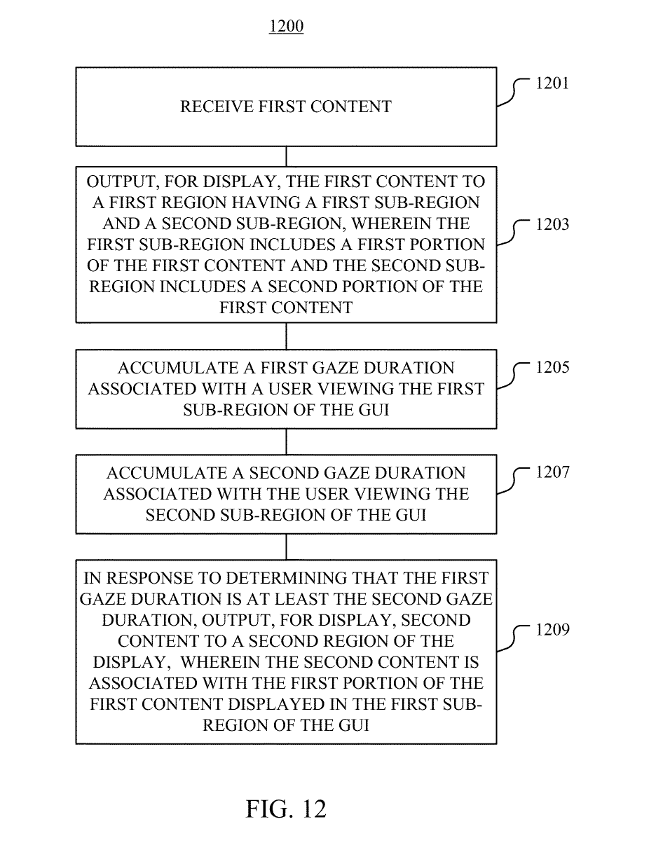

FIG. 12 is a flowchart of another embodiment of a method 1200 for improved delivery of contextual data using eye tracking technology to a computing device with various aspects described herein. In FIG. 12, the method 1200 may begin, for instance, at block 1201, where it may include receiving, at the computing device, first content. At block 1203, the method 1200 may output, for display, the first content to a first region having a first sub-region and a second sub-region. The first sub-region may include a first portion of the first content. Further, the second sub-region may include a second portion of the first content. At block 1205, the method 1200 may accumulate a first gaze duration associated with a user viewing the first sub-region of the graphical user interface. Further, at block 1207, the method 1200 may accumulate a second gaze duration associated with a user viewing the second sub-region of the graphical user interface. In response to the first gaze duration being at least the second gaze duration, at block 1209, the method 1200 may output, for display, second content to a second region of the graphical user interface. The second content may be associated with the first portion of the first content displayed in the first sub-region of the graphical user interface.

In another embodiment, a method may include receiving, from a sensor, gaze data associated with a user of the computing device viewing a display associated with the computing device. Further, the method may include mapping the gaze data to a gaze location of the graphical user interface. In response to the gaze location being in the first sub-region of the graphical user interface, the method may include accumulating the first gaze duration.

In another embodiment, a method may include receiving, from a sensor, gaze data associated with a user of the computing device viewing a display associated with the computing device. Further, the method may include mapping the gaze data to a gaze location of the graphical user interface. In response to the gaze location being in the second sub-region of the graphical user interface, the method may include accumulating the second gaze duration.

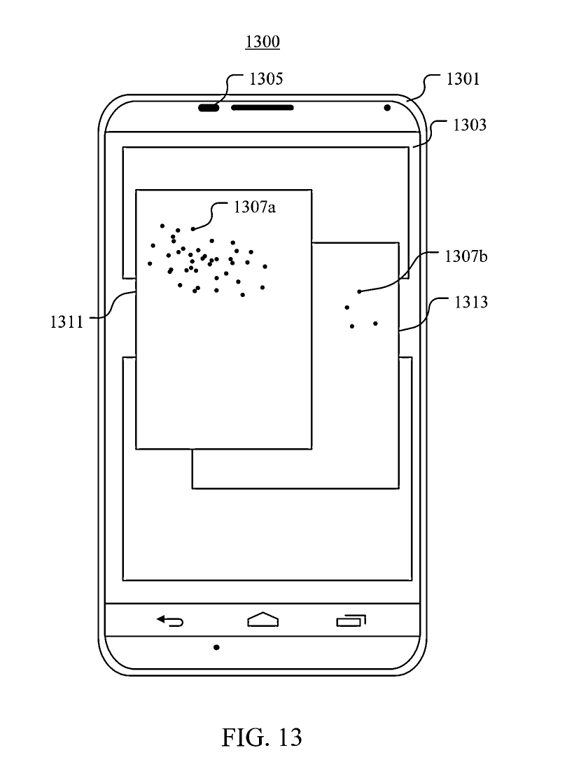

FIG. 13 illustrates another embodiment of a front view of a computing device 1300 in portrait orientation with various aspects described herein. In FIG. 13, the computing device 1300 may be configured to include a housing 1301, a display 1303 and a sensor 1305. The housing 1301 may be configured to house the internal components of the computing device 1300 such as those described in FIG. 1 and may frame the display 1303 such that the display 1303 is exposed for user-interaction with the computing device 1300. The sensor 1305 may be used to detect characteristics of a user of the computing device 1300 such as a user's eye or eye lid movements, a user's facial expressions or the like while a user is viewing the graphical user interface 1303 of the computing device 1300. The sensor 1305 may be, for instance, an optical sensor, a digital camera, a digital video camera, or the like.

In one embodiment, the computing device 1300 may output, for display, a first region 1311 and a second region 1313 of a graphical user interface. In one example, each of the first region 1311 and the second region 1313 of the graphical user interface may be a window. Further, the computing device 1300 may determine a first dwell time associated with a user viewing the first region 1311 of the graphical user interface. Based on the inference or determination of a plurality of gaze locations 1307a and 1307b, the computing device 1300 may determine the first dwell time and the first dwell location. The plurality of gaze locations 1307a and 1307b are provided in FIG. 10 for illustrative purposes and may not be displayed on the graphical user interface during operation of the computing device 1300. The computing device 1300 may receive, from the sensor 1305, gaze data associated with a user viewing the display 1303. Further, the computing device 1300 may map the gaze data to a location of the graphical user interface to determine one of the plurality of gaze locations 1307a and 1307b. In response to a portion of the plurality of gaze locations 1307a and 1307b corresponding to the first dwell location associated with the first region 1311 of the graphical user interface, the computing device 1000 may determine the first dwell time.

Furthermore, in response to determining that the first dwell time is at least a minimum dwell time, the computing device 1300 may activate the first region 1311 of the graphical user interface by, for instance, launching an application associated with the first region 1311, placing frontmost the first region 1311, placing frontmost the first region 1311 and any associated regions such as all regions associated with a particular application, placing the first region 1311 in a prominent location of the graphical user interface such as the center or the upper-left portion of the graphical user interface, spreading any overlapping regions so that such regions do not overlap, tiling the regions, enlarging a size of the first region 1311 to fit all or a portion of the graphical user interface, reducing the size of the first region 1311, minimizing the second region 1313, removing the second region 1313, or the like. The computing device 1300 may output, for display, the activated first region of the graphical user interface.

In another embodiment, the computing device 1300 may output, for display, a first region 1311 and a second region 1313 of a graphical user interface. In one example, each of the first region 1311 and the second region 1311 may be a virtual window. Further, the computing device 1300 may accumulate a first gaze duration associated with a user viewing the first region 1311 of the graphical user interface. Similarly, the computing device 1300 may accumulate a second gaze duration associated with a user viewing the second region 1313 of the graphical user interface. The computing device 1300 may receive, from the sensor 1305, gaze data associated with a user viewing the display 1303. Further, the computing device 1300 may map the gaze data to a location of the graphical user interface to determine one of the gaze locations 1307a and 1307b. In response to one of the plurality of gaze location 1307a and 1307b being in the first region 1311 of the graphical user interface, the computing device 1300 may accumulate the first gaze duration. Similarly, the computing device 1300 may accumulate a second gaze duration associated with a user viewing the second region 1313 of the graphical user interface. In response to one of the plurality of gaze location 1307a and 1307b being in the second region 1313 of the graphical user interface, the computing device 1300 may accumulate the second gaze duration.

Furthermore, in response to determining that the first gaze duration is at least the second gaze duration, the computing device 1300 may activate the first region 1312 of the graphical user interface by, for instance, launching an application associated with the first region 1311, placing frontmost the first region 1311, placing frontmost the first region 1311 and any associated regions such as any regions associated with a particular application, placing the first region 1311 in a prominent location of the graphical user interface such as the center or the upper-left portion of the graphical user interface, spreading any overlapping regions so that such regions do not overlap, tiling all or some of the regions, enlarging a size of the first region 1311 to fit any portion of the graphical user interface, reducing the size of the first region 1311, minimizing the second region 1313, removing the second region 1313, ordering the first region 1311 and the second region 1313 for display based on a ranking of the first gaze duration and the second gaze duration, the like, or any combination thereof. The computing device 1300 may output, for display, the activated first region of the graphical user interface.

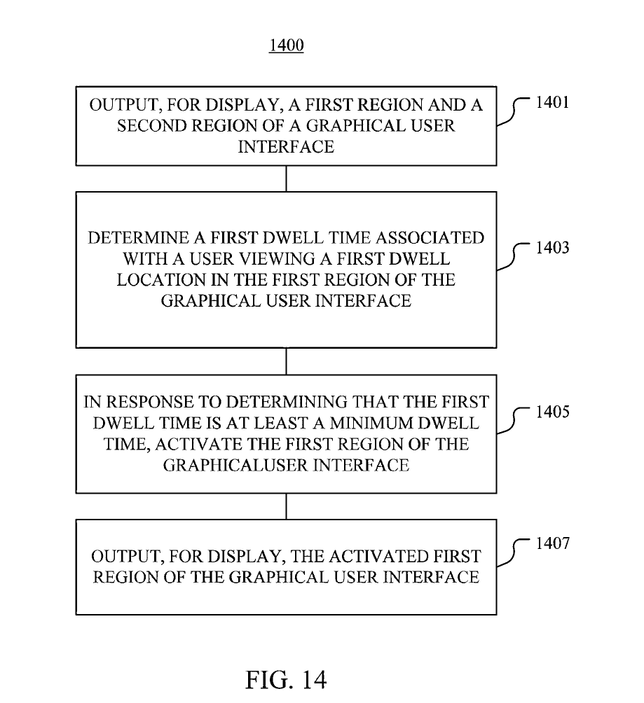

FIG. 14 is a flowchart of one embodiment of a method 1400 for activating a window of a graphical user interface using eye tracking technology with various aspects described herein. In FIG. 14, the method 1400 may begin, for instance, at block 1401, where it may include outputting, for display, a first region and a second region of a graphical user interface. At block 1403, the method 1400 may determine a first dwell time associated with a user viewing a first dwell location associated with the first region of the graphical user interface. In response to determining that the first dwell time is at least a minimum dwell time, at block 1405, the method 1400 may activate the first region of the graphical user interface. At block 1407, the method 1400 may output, for display, the activated first region of the graphical user interface.

In another embodiment, a method may include activating the first region by launching an application associated with the first region.

In another embodiment, a method may include activating the first region by placing the first region as the frontmost region.

In another embodiment, a method may include activating the first region by determining that the second region is associated with the first region and placing the first region and the second region as the frontmost regions. In one example, the second region may be associated with the same application as the first region.

In another embodiment, a method may include activating the first region by placing the first region in a prominent location of the graphical user interface.

In another embodiment, a method may include activating the first region by determining that the first region and the second region overlap and moving at least one of the first region and the second region so that the first region and the second region do not overlap.

In another embodiment, a method may include activating the first region by tiling the first region and the second region.

In another embodiment, a method may include activating the first region by increasing a size of the first region.

In another embodiment, a method may include activating the first region by decreasing a size of the second region.

In another embodiment, a method may include activating the first region by minimizing the second region.

In another embodiment, a method may include activating the first region by removing, from display, the second region.

In another embodiment, the first region may be a first window of the graphical user interface and the second region may be a second window of the graphical user interface.

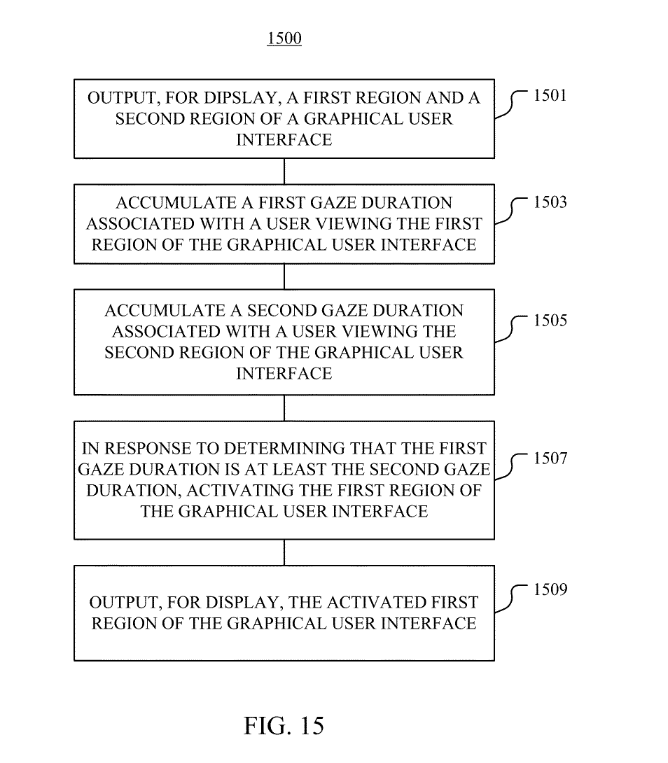

FIG. 15 is a flowchart of one embodiment of a method 1500 for activating a window of a graphical user interface using eye tracking technology with various aspects described herein. In FIG. 15, the method 1500 may begin, for instance, at block 1501, where it may include outputting, for display, a first region and a second region of a graphical user interface. At block 1503, the method 1500 may accumulate a first gaze duration associated with a user viewing the first region of the graphical user interface. At block 1505, the method 1500 may accumulate a second gaze duration associated with a user viewing the second region of the graphical user interface. In response to determining that the first gaze duration is at least the second gaze duration, at block 1507, the method 1500 may activate the first region of the graphical user interface. At block 1509, the method 1500 may output, for display, the activated first region of the graphical user interface.

It is important to recognize that it is impractical to describe every conceivable combination of components or methodologies for purposes of describing the claimed subject matter. However, a person having ordinary skill in the art will recognize that many further combinations and permutations of the subject technology are possible. Accordingly, the claimed subject matter is intended to cover all such alterations, modifications and variations that are within the spirit and scope of the claimed subject matter.

In the foregoing specification, specific embodiments have been described. However, one of ordinary skill in the art will appreciate that various modifications and changes may be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. This disclosure is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” or the like does not, without more constraints, preclude the existence of additional identical elements in the process, method, article, or apparatus that comprises, has, includes, contains the element. The terms “a,” “an,” and “the” are defined as one or more unless explicitly stated otherwise herein. The term “or” is intended to mean an inclusive “or” unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

Furthermore, the term “connected” means that one function, feature, structure, component, element, or characteristic is directly joined to or in communication with another function, feature, structure, component, element, or characteristic. The term “coupled” means that one function, feature, structure, component, element, or characteristic is directly or indirectly joined to or in communication with another function, feature, structure, component, element, or characteristic. References to “one embodiment,” “an embodiment,” “example embodiment,” “various embodiments,” and other like terms indicate that the embodiments of the disclosed technology so described may include a particular function, feature, structure, component, element, or characteristic, but not every embodiment necessarily includes the particular function, feature, structure, component, element, or characteristic. Further, repeated use of the phrase “in one embodiment” does not necessarily refer to the same embodiment, although it may.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches may be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

This detailed description is merely illustrative in nature and is not intended to limit the present disclosure, or the application and uses of the present disclosure. Furthermore, there is no intention to be bound by any expressed or implied theory presented in the preceding field of use, background, or this detailed description. The present disclosure provides various examples, embodiments and the like, which may be described herein in terms of functional or logical block elements. Various techniques described herein may be used for improved delivery of contextual data to a computing device having eye tracking technology. The various aspects described herein are presented as methods, devices (or apparatus), systems, or articles of manufacture that may include a number of components, elements, members, modules, nodes, peripherals, or the like. Further, these methods, devices, systems, or articles of manufacture may include or not include additional components, elements, members, modules, nodes, peripherals, or the like. Furthermore, the various aspects described herein may be implemented using standard programming or engineering techniques to produce software, firmware, hardware, or any combination thereof to control a computing device to implement the disclosed subject matter. The term “article of manufacture” as used herein is intended to encompass a computer program accessible from any computing device, carrier, or media. For example, a non-transitory computer-readable medium may include: a magnetic storage device such as a hard disk, a floppy disk or a magnetic strip; an optical disk such as a compact disk (CD) or digital versatile disk (DVD); a smart card; and a flash memory device such as a card, stick or key drive. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art will recognize many modifications may be made to this configuration without departing from the scope or spirit of the claimed subject matter.

What is claimed is:

1. A method, comprising:
receiving, by a computing device, first content and second content;
outputting, by the computing device, for display, the first content to a first region of a graphical user interface and the second content to a second region of the graphical user interface;
accumulating a first gaze duration associated with a user viewing the first region of the graphical user interface;
accumulating a second gaze duration associated with a user viewing the second region of the graphical user interface;
determining a first metric associated with the first content and a second metric associated with the second content using the first gaze duration and the second gaze duration; and
sending, from the computing device, the first metric and the second metric.

2. The method of claim 1, wherein accumulating the first gaze duration associated with a user viewing the first region of the graphical user interface includes:
receiving, by the computing device, from a presence-sensitive input device, gaze data associated with a user viewing a presence-sensitive display;
mapping the gaze data to a gaze location of the graphical user interface; and
in response to the gaze location being in the first region of the graphical user interface, accumulating the first gaze duration.

3. The method of claim 1, wherein accumulating the second gaze duration associated with a user viewing the second region of the graphical user interface includes:
receiving, by the computing device, from a presence-sensitive input device, gaze data associated with a user viewing a presence-sensitive display;
mapping the gaze data to a gaze location of the graphical user interface; and
in response to the gaze location being in the second region of the graphical user interface, accumulating the second gaze duration.

4. The method of claim 1, further comprising:
accumulating a viewing duration corresponding to an amount of time that a user views the graphical user interface; and
determining the first metric and the second metric responsive to the viewing duration being at least a minimum viewing duration.

5. The method of claim 4, wherein accumulating the viewing duration includes:
receiving, by the computing device, from a presence-sensitive input device, gaze data associated with a user viewing a presence-sensitive display; and
in response to receiving the gaze data, accumulating the viewing duration.

6. The method of claim 4, wherein accumulating the viewing duration is responsive to outputting at least one of the first content and the second content.

7. The method of claim 1, further comprising:
accumulating a viewing duration corresponding to an amount of time that a user views the graphical user interface; and
determining the first metric and the second metric using the viewing duration.

8. The method of claim 1, further comprising:
determining a non-viewing time corresponding to an amount of time that a user does not view a presence-sensitive display; and
determining the first metric and the second metric responsive to the non-viewing time being at least a minimum non-viewing time.

9. The method of claim 1, further comprising:
determining a non-viewing time corresponding to an amount of time that a user does not view a presence-sensitive display; and
placing the presence-sensitive display into a lower power mode in response to the non-viewing time being at least a non-viewing time threshold associated with a time sufficient to determine that a user is no longer viewing the presence-sensitive display.

10. The method of claim 1, further comprising:
determining a non-viewing time corresponding to an amount of time that a user does not view a presence-sensitive display; and
reducing a duty cycle of a presence-sensitive input device in response to the non-viewing time being at least a non-viewing time threshold associated with a time sufficient to determine that a user is no longer viewing the presence-sensitive display.

11. The method of claim 1, wherein accumulating the first metric and the second metric is performed over a predetermined time associated with a time sufficient to quantify a user's interest in viewing content.

12. The method of claim 11, wherein determining the first metric and the second metric includes using the predetermined time.

13. The method of claim 6, further comprising:
in response to sending the first metric and the second metric, receiving, by the computing device, third content; and
outputting, by the computing device, for display, the third content.

14. The method of claim 13, wherein outputting the third content includes:
in response to the first metric being at least the second metric, outputting, by the computing device, for display, the third content to the second region of the graphical user interface.

15. The method of claim 13, wherein outputting the third content includes:
in response to the first metric being at least the second metric, outputting, by the computing device, for display, the third content to the first region of the graphical user interface.

16. The method of claim 15, further comprising:
removing, from display, the second content in the second region of the graphical user interface.

17. The method of claim 13, wherein outputting the third content to the graphical user interface is to a third region of the graphical user interface.

18. The method of claim 13, wherein the third content is associated with the first content.

19. The method of claim 1, wherein each of the first content and the second content is a search result.

20. The method of claim 1, wherein each of the first content and the second content is an advertisement.

21. A portable communication device, comprising:
a presence-sensitive display;
a memory configured to store data and computer-executable instructions; and
a processor operatively coupled to the memory and the presence-sensitive display, wherein the processor and memory are configured to:
receive first content and second content;
output, for display at the presence-sensitive display, the first content to a first region of a graphical user interface and the second content to a second region of the graphical user interface;
accumulate a first gaze duration associated with a user viewing the first region of the graphical user interface;
accumulate a second gaze duration associated with a user viewing the second region of the graphical user interface;
determine a first metric associated with the first content and a second metric associated with the second content using the first gaze duration and the second gaze duration; and
send the first metric and the second metric.
